(19) United States
(12) Patent Application Publication
(10) Pub. No.: US 2005/0278959 A1
(43) Pub. Date: Dec. 22, 2005

(54) Circular saws with power indication lamps

(75) Inventors: Takeshi Nishimiya, Anjo-shi (JP); Toshihiko Suzuki, Anjo-shi (JP); Jiro Suzuki, Anjo-shi (JP); Yuki Wada, Anjo-shi (JP); Toshiyuki Kani, Anjo-shi (JP)

Correspondence Address: OLIFF & BERRIDGE, PLC, P.O. BOX 19928, ALEXANDRIA, VA, 22320, US

(73) Assignee: MAKITA CORPORATION, Anjo-shi (JP)

(21) Appl. No.: 11/147,386

(22) Filed: Jun. 8, 2005

(30) Foreign Application Priority Data
Jun. 10, 2004 (JP) 2004-172699

(51) Int. Cl. B23D 45/16

(52) U.S. Cl. 30/388; 30/132

(57) ABSTRACT

A power driven circular saw includes a base able to slidingly contact a workpiece and a saw unit positioned above the base and supported by the base. The saw unit includes a motor case accommodating an electric motor, a handle extending from the motor case and able to be grasped by an operator, a circular saw blade rotatably driven by the electric motor and positioned to partly extend downward below the lower surface of the base, and a blade case for substantially covering the upper half of the saw blade. A power indication lamp is disposed on one side of the handle and is illuminated when power is supplied to the circular saw.

This application claims priority to Japanese patent application Ser. No. 2004-172699, the contents of which are incorporated herein by reference.

### BACKGROUND OF THE INVENTION

1. Field of the Invention

The present invention relates to power tools, such as portable power tools, and in particular to power tools having power cords with plugs for connecting to a power receptacle of a commercial or residential power source.

2. Description of the Related Art

Portable circular saws have been generally used to cut various types of materials, wooden materials for example, at a home building site. Thus, the portable circular saw may be hand-carried by an operator to a work site. The operator will then connect a power cord of the circular saw to a power receptacle at the work site so that power is supplied to the circular saw for performing a cutting operation.

In order to recognize whether or not the power cord has been connected to the power receptacle (i.e., whether or not the power is being directly supplied to the circular saw), the operator would typically move to a place adjacent to the power receptacle in order to visually observe the connecting status or condition. Otherwise, the operator may turn on the start switch of the motor of the circular saw and observe the rotation or operation (or lack thereof) of the saw blade.

Japanese Laid-Open Patent Publication No. 5-200703 teaches a router that is used for grooving and shaping materials, for example, wooden materials. This router has a power indication lamp that is illuminated when the power cord of the router is connected to a power receptacle so as to supply power to the power source circuit of the router. With this router, the power indication lamp enables the operator to quickly and visually recognize whether or not the power cord has been connected to a power receptacle, without requiring the operator to physically move to a place in order to directly observe the power receptacle connection and without requiring the operator to turn on the start switch of the router. Further, Japanese Laid-Open Patent Publication No. 10-49077 teaches various kinds of ornamental lamps. In one embodiment, the ornamental lamp is an LED lamp that has an LED and a bulb body. A conical recess is formed in the top end of the bulb body so that a portion of the light emitted from the LED is diffused upon passing through the surface of the conical recess. The remaining quantity of light passes through the lateral side of the bulb body. Therefore, the light emitted from the lamp covers a wide area and can be easily recognized.

Contrary to the case of the router, no power indication lamp has been provided on conventional portable circular saws due to the differences in the positions or the orientations of the portable circular saws when the circular saws are not actively being used. Thus, in the case of the router, the router may take substantially the same orientation between a working position (hereinafter called an “operative position”) where the router is set onto a worktable or set with respect to material for a grooving or routing operation and a position (hereinafter called a “resting position”) where the router is normally stably placed on the worktable or on some other surface when the operator is not actively using the router. Therefore, the operator may easily observe the power indication lamp regardless of the position of the router. The power indication lamp only needs to be mounted in such a position that the operator can observe the power indication lamp in one of the operative position or the resting position of the router, and the lamp will be visible in the other of the resting position or operative position.

In the case of circular saws, a circular saw normally has a base for slidably contacting the upper surface of a workpiece to be cut and a circular saw blade that extends partly downward through the base in order to cut the workpiece during a cutting operation. Therefore, it is typically not possible to place the circular saw onto a worktable or the like and have the circular saw adopt the same orientation used during the cutting operation. For this reason, the circular saw may normally rest on a worktable or the like in a position obliquely inclined relative to the surface of the worktable or the like with either the base oriented upward (hereinafter called the “inverted inclined resting position”) or with the base oriented downward (hereinafter called the “normal inclined resting position”).

In this way, the rest position (normal inclined resting position or inverted inclined resting position) of the circular saw is considerably different from the operative position used during a cutting operation. In addition, the resting position is variable, not fixed or consistent. Therefore, it is difficult to mount a power indication lamp on a circular saw such that the operator can always observe the power indication lamp in the operative position and in all of the possible resting positions of the circular saw. This is the reason why power indication lamps indicating the power supply condition are not known on portable circular saws.

### SUMMARY OF THE INVENTION

It is accordingly an object of the present invention to teach a portable power driven circular saw having a power indication lamp that can be observed irrespective of the possible positions or orientations of the circular saw.

In one aspect of the present teachings, power driven circular saws are taught that include a base adapted to slidingly contact a workpiece and a saw unit positioned above and supported by the base. The saw unit includes a motor case accommodating an electric motor, a handle extending from the motor case and adapted be grasped by an operator, a circular saw blade rotatably driven by the electric motor and positioned so as to partly extend downward below the lower surface of the base, and a blade case for substantially covering the upper half of the saw blade. A power indication lamp is disposed on one side of the handle and emits light when electric power is supplied to the circular saw for driving the motor.

With this arrangement, the light of the power indication lamp can be observed or recognized by an operator even in the event that the circular saw is oriented in various positions, such as an operative position for cutting the workpiece and an inoperative or a resting position where the circular saw is placed on the surface of a worktable or the like.

Therefore, the operator can easily recognize that power is supplied to the circular saw without the need of any troublesome further operations. For example, the operator is not required to move toward the power receptacle in order to directly observe whether or not the power cord of the circular saw is connected to the power receptacle. It is also not necessary to operate the start switch of the motor in order to observe whether or not there is rotation of the circular saw blade.

In addition, because the power indication lamp can be easily observed or recognized from the outside of the circular saw, the operator can easily distinguish the circular saw, which is connected to the power receptacle, from any of the other power tools that are used together with the circular saw and that may be placed in the same location as the circular saw. Therefore, the operator can quickly prepare for a cutting operation using the circular saw.

In one embodiment, the blade case is positioned on one of the right side or the left side of the handle with respect to a cutting direction. The power indication lamp is mounted to the handle in a position opposing the blade case so that the light emitted from the power indication lamp is reflected by the blade case. This position of the power indication lamp enables indirect recognition of the lighting condition of the power indication lamp.

With this arrangement, even in the event that the operator cannot directly observe the power indication lamp, the operator can indirectly observe the light of the lamp reflected by the blade case. Therefore, the circular saw with a power indication lamp is further improved in this respect.

In another embodiment, the position of the power indication lamp is set such that the power indication lamp is oriented upward relative to a surface on which the circular saw is placed in a resting position. The resting positions include a normal inclined resting position with a rear portion of the base and the lower end of the motor case contacting the surface and an inverted inclined resting position with an upper end of the handle and the upper end of the motor case contacting the surface. Therefore, the operator can more easily observe the power indication lamp, since the operator may typically observe the circular saw from an upper perspective or vantage point in most instances.

In a further embodiment, the power indication lamp includes a substantially transparent lens that has an end portion extending outside beyond a side surface of the handle. Here, the term “substantially transparent” is used to indicate transparent with or without color and also translucent with or without color. The end portion has a substantially conical outer circumferential surface. A central recess is formed in an end surface of the end portion of the lens and has a substantially conical inner circumferential surface. With this configuration of the lens, the light may widely scatter laterally from the end portion of the lens while the light travels along the light axis, i.e., towards the front side of the end portion of the lens. Therefore, an operator can more easily observe the light emitted from the power indication lamp.

### BRIEF DESCRIPTION OF THE DRAWINGS

FIG. 1 is a right side view of a representative power driven circular saw and showing a view taken along line (1)-(1) in FIG. 2; and

FIG. 2 is a plan view of the circular saw; and

FIG. 3 is an enlarged cross sectional view taken along line (3)-(3) in FIG. 1 and showing a power indication lamp; and

FIG. 4 is a schematic view of the circular saw as viewed from a rear side with respect to the cutting direction and showing an operative position during a cutting operation of the circular saw; and

FIG. 5 is a schematic view similar to FIG. 4 but showing a normal inclined resting position of the circular saw; and

FIG. 6 is a schematic view similar to FIG. 5 but showing an inverted inclined resting position of the circular saw.

### DETAILED DESCRIPTION OF THE INVENTION

Each of the additional features and teachings disclosed above and below may be utilized separately or in conjunction with other features and teachings to provide improved power driven circular saws and methods of manufacturing such circular saws. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

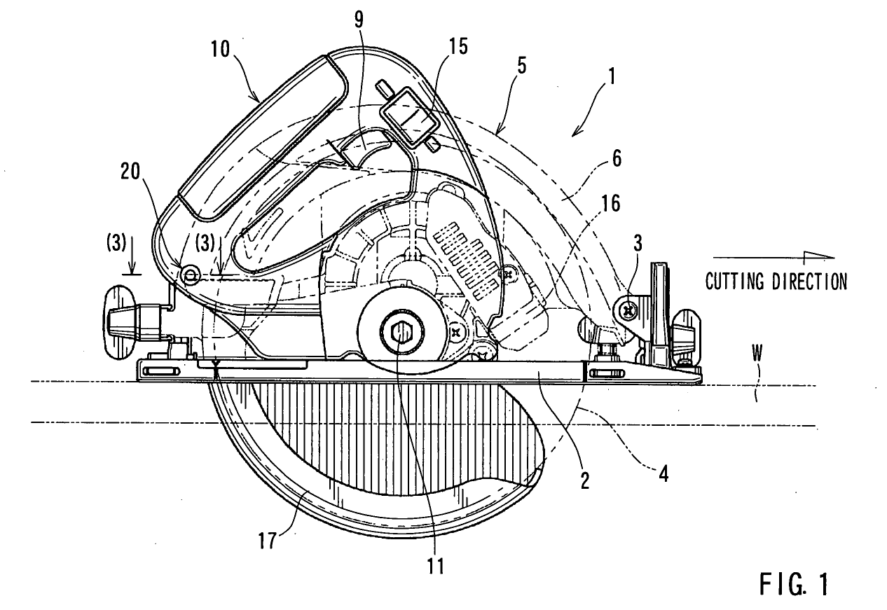

A representative embodiment of the present invention will now be described with reference to FIGS. 1 to 6. The representative embodiment relates to an improvement of a power driven circular saw 1 to include a power indication lamp 20. Other than the power indication lamp 20 and the related construction of the power indication lamp 20, the general construction of the circular saw 1 is the same as a known circular saw. Therefore, the general construction of the circular saw 1 will only be briefly described.

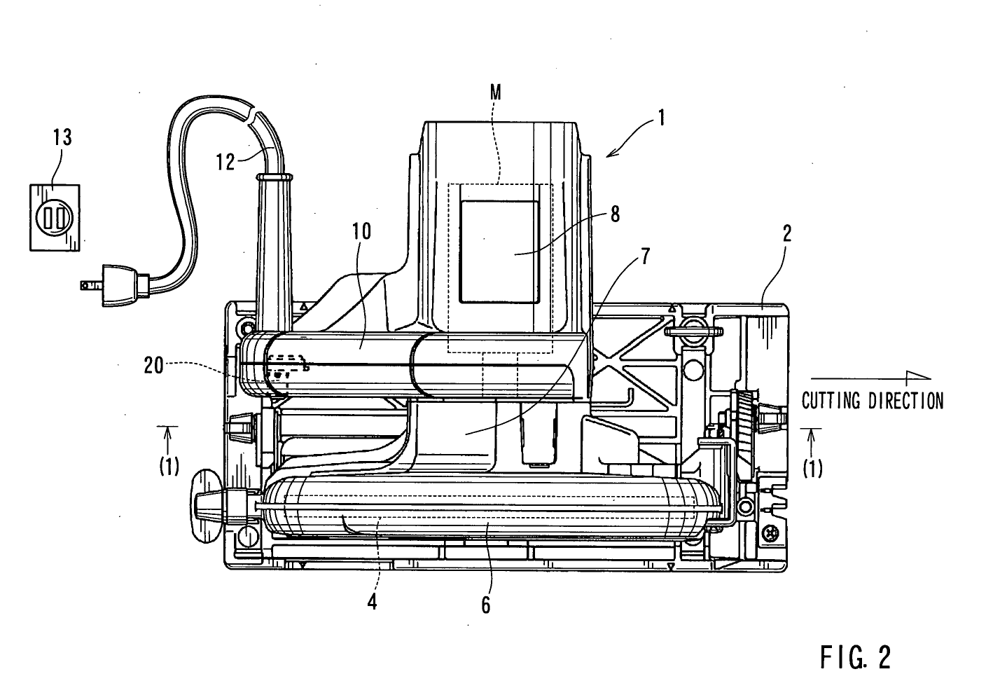

Referring to FIG. 1, the circular saw 1 generally includes a base 2 and a saw unit 5. The base 2 is adapted to slidingly contact a workpiece W during a cutting operation. The saw unit 5 is vertically pivotally mounted to the base 2 via a pivotal support 3. The saw unit 5 has an electric motor M (see FIG. 2) as a drive source and has a circular saw blade 4 that is rotatably driven by the motor M. More specifically, the rotation of the motor M is transmitted to a spindle 11. The saw blade 4 is mounted to the spindle 11.

As shown in FIG. 1, the lower portion of the saw blade 4 extends downward beyond the lower surface of the base. 2 via a slot (not shown) formed in the base 2. The downward extending distance of the saw blade 4 from the base 2 can be adjusted by vertically pivoting the saw unit 5 about the pivotal support 3. As a result, the cutting depth of the saw blade 3 into the workpiece W can be adjusted.

The lower portion of the saw blade 4, extending downward from the base 2, is covered by a safety cover 17. The safety cover 17 can move in the circumferential direction about the central axis of the saw blade 4 in order to cover and uncover the lower portion of the saw blade 4. To this end, the safety cover 17 is movably supported by a blade case 6 of the saw unit 5.

Referring to FIG. 2, the blade case 6 covers substantially the upper half of the saw blade 4 and is preferably cast from aluminum so as to be moderately glossy. A gear case 7 is formed integrally with a left side portion (the upper portion as viewed in FIG. 2) of the blade case 6 and accommodates a reduction gear mechanism (not shown). A motor case 8 is mounted to the gear case 7 and accommodates the motor M. An output shaft of the motor M is coupled to the reduction gear mechanism, which has an output shaft coupled to the spindle 11.

A handle 10 is adapted to be grasped by the operator and is mounted on a right side portion (the lower portion as viewed in FIG. 2) of the motor case 8. As shown in FIG. 1, the handle 10 extends upward and rearward from the motor case 8. The handle 10 has a substantially D-shaped configuration as viewed in a side view. A start switch 9, configured as a trigger, is mounted to an upper wall of the D-shaped space defined in the handle 10. The start switch 9 is electrically connected to the motor M. The motor M starts to rotate the circular saw blade 4 when the operator grasps the handle 10 and depresses the start switch 9.

The power indication lamp 20 is mounted to a right and rear side portion of the handle 10. Here, the right and rear side is used to mean the right and rear side with respect to a cutting direction (the rightward direction as indicated by the arrow in FIG. 1), i.e., the right and rear side as viewed from the orientation of an operator who is grasping the handle 10 during a cutting operation. More specifically, the power indication lamp 20 is positioned to oppose the backside of the blade case 6. A power cord 12 extends from the left rear side of the handle 10.

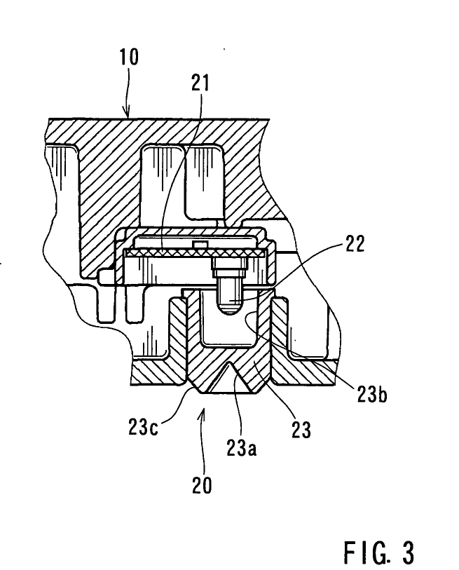

The power indication lamp 20 is shown in detail in FIG. 3. Referring to FIG. 3, the power indication lamp 20 has an LED 22 as a light source. The LED 22 is mounted to a circuit board 21 that is assembled within the handle 10 together with the LED 22. A substantially cylindrical transparent lens 23 is disposed on the front side (the lower side as viewed in FIG. 3) of the LED 22. A recess 23b is formed in the rear surface (the upper surface as viewed in FIG. 3) of the lens 23 in order to partly receive the LED 22.

The front end (the lower end as viewed in FIG. 3) of the lens 23 is exposed to the outside of the handle 10. More specifically, the front end of the lens 23 extends beyond the right side surface (lower surface as viewed in FIG. 3) of the handle 10. The extended front end of the lens 23 has a conical outer circumferential surface 23c extending throughout the circumference of the front end of the lens 23. In addition, a conical central recess 23a is formed in the end surface of the extended front end of the lens 23 and includes a V-shaped cross section as shown in FIG. 3. With this type of arrangement, the illumination of the lamp 20 can be observed from either the front side or a lateral side of the lamp 20.

The lamp 20, constructed as described above, is assembled within a power source circuit (not shown) of the motor M. Therefore, when the power cord 12 is connected to the commercial power receptacle 13 shown in FIG. 2, power is supplied to the power source circuit and is then supplied to the LED 22, resulting in the LED 22 emitting light. With the power thus supplied to the power source circuit, the motor M may rotate the saw blade 4 when the operator turns on the start switch 9. When the power cord 12 is disconnected or removed from the power receptacle 13, the supply of power to the power source circuit is interrupted. As a result, the LED 22 is turned off or not illuminated.

Further, in this representative embodiment a lighting switch 15 is mounted to a front portion of the handle 10. In connection with the lighting switch 15, a light 16 is disposed within the blade case 6 and emits light when the lighting switch 15 is switched on. The light 16 is oriented toward a portion of the workpiece W that will be cut by the saw blade 4. Therefore, when the light 16 is illuminated, the operator can easily visually observe a portion of the workpiece W that will be cut, even during a cutting operation in a relatively dark work environment. The light 16 is also electrically connected to the power source circuit of the motor M via the lighting switch 15, so that power is supplied to the light 16 via the light switch 15 when the power cord 12 is connected to the power receptacle 13.

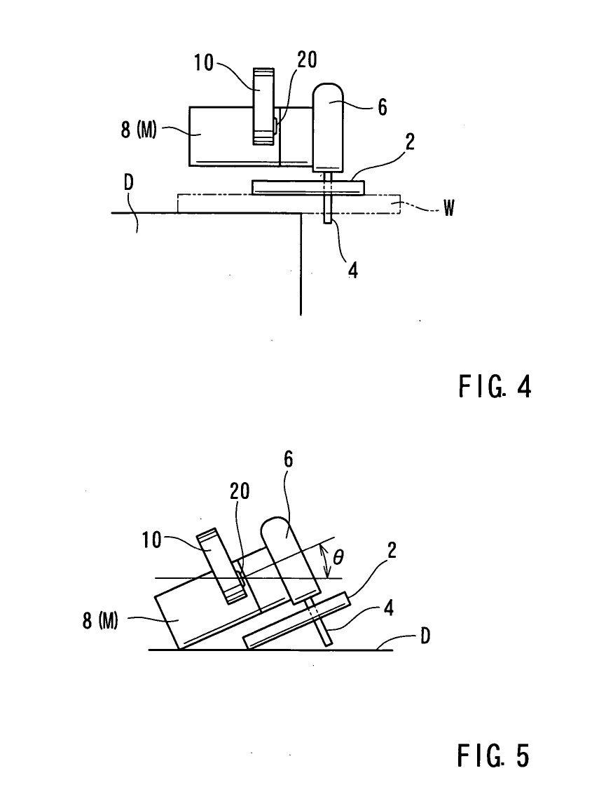

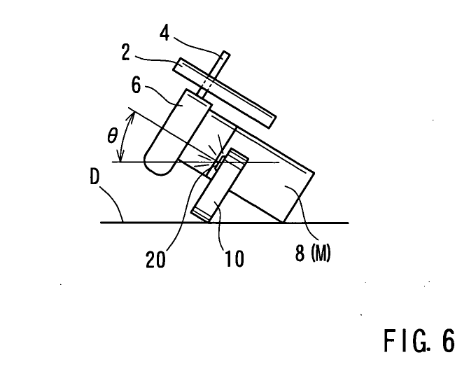

In operation of the above representative circular saw 1, the power indication lamp 20 is illuminated when the power cord 12 is connected to the power receptacle 13. As previously described, the power indication lamp 20 is disposed on the right side surface of the handle 10 with respect to the cutting direction of the circular saw 1, while the handle 10 projects upward from the motor case 8. Therefore, the operator can visually observe the power indication lamp 20, in particular the light emitted from the LED 22, in the case where the circular saw 1 is in an operative position shown in FIG. 4, a normal inclined resting position shown in FIG. 5, or the inverted inclined resting position shown in FIG. 6. In the normal inclined resting position shown in FIG. 5, the circular saw 1 is placed on a worktable D with the left end of the base 2 and the lower end (the left end as shown in FIG. 5) of the motor case 8 contacting the surface of the worktable D. In the inverted inclined resting position shown in FIG. 6, the circular saw 1 is placed on the worktable D while being oriented upside down from the position shown in FIG. 5. In the inverted inclined resting position shown in FIG. 6 the upper left portion of handle 10 and the upper end (the left end as shown in FIG. 6) of the motor case 8 contact the surface of the worktable D.

In addition, in this representative embodiment the power indication lamp 20, i.e., the LED 22, is positioned to oppose the backside of the blade case 6. Therefore, even in the event that the circular saw 1 assumes a position that causes difficulty for the operator to directly observe the power indication lamp 20, the operator can indirectly recognize whether or not the power indication lamp 20 is illuminated by the light that is reflected off of the backside surface (i.e., the left side of the blade case 6 in FIG. 2) of the blade case 6 after being emitted by the power indication lamp 20.

Furthermore, as shown in FIGS. 5 and 6, in either the normal inclined resting position or the inverted inclined resting position, the light axis of the power indication lamp 20, i.e., the LED 22, is inclined upward by an angle 0 relative to a plane parallel to the surface of the worktable D, i.e., the horizontal plane. In most usual cases at a typical worksite, the operator will be looking down on the circular saw 1 from a point higher than the circular saw 1. Therefore, this arrangement helps to ensure that the power indication lamp 20 can be visually observed or recognized by an operator from above. The value of the angle θ in the normal inclined resting position may be the same or different from the value of the angle θ in the inverted inclined resting position.

Although the representative embodiment has been described in connection with the placement of the circular saw 1 on the worktable D, the same operations and advantages can be attained when the circular saw 1 is placed on a floor or put on a shelf.

### Other Possible Embodiments

The present invention is not limited to the embodiment describe above but may be modified in various ways. For example, the LED 22 is incorporated as a light source in the representative embodiment. However, an incandescent lamp, a fluorescent lamp, or other illuminating device may be used.

In addition, the transparent lens 23 may be colorless or may have a color. Alternatively, the lens 23 may be translucent and also may be colorless or may have a color.

Further, although the above representative embodiment has been described in connection with the circular saw 1 having the blade case 6 disposed on the right side of the handle 10 with respect to the cutting direction, the present invention may also be applied to a circular saw having a blade case disposed on the left side of a handle by positioning the power indication lamp 20 on the corresponding left side surface of the handle.

1. A power driven circular saw comprising:
a base arranged and constructed to contact a workpiece; and
a saw unit positioned above the base and supported by the base, the saw unit comprising:
a motor case accommodating an electric motor; and
a handle extending from the motor case and arranged and constructed to be grasped by an operator; and
a circular saw blade rotatably driven by the electric motor and positioned to partly extend downward below a lower surface of the base; and
a blade case arranged and constructed to substantially cover an upper half of the saw blade; and
a power indication lamp disposed on one side of the handle and arranged and constructed to emit light when power is supplied to the circular saw.

2. The circular saw as in claim 1,
wherein the blade case is positioned on one of a right side or a left side of the handle with respect to a cutting direction;
wherein the power indication lamp is mounted on the handle in a position opposing the blade case, so that the light emitted from the power indication lamp is reflected by the blade case in order to enable indirect recognition of the illumination of the power indication lamp.

3. The circular saw as in claim 1,
wherein the position of the power indication lamp is determined such that the power indication lamp is oriented upward relative to a surface on which the circular saw is placed in a resting position;
wherein the resting position includes one of an inclined resting position or an inverted inclined resting position;
wherein the inclined resting position includes the circular saw oriented so that an end portion of the base and a lower end of the motor case contact the surface; and
wherein the inverted inclined resting position includes the circular saw oriented so that an upper end of the handle and a upper end of the motor case contact the surface.

4. The circular saw as in claim 1,
wherein the power indication lamp comprises a substantially transparent lens;
wherein the lens has an end portion extending beyond a side surface of the handle,
wherein the end portion has a substantially conical outer circumferential surface and a central recess formed in an end surface of the end portion and having a substantially conical inner circumferential surface.

5. A power driven circular saw comprising:
a base arranged and constructed to slidingly contact a workpiece; and
a saw unit supported on the base, the saw unit comprising:
a motor case accommodating an electric motor and having a first end and a second end along a longitudinal axis;
a handle extending from the motor case and arranged and constructed to be grasped by an operator, wherein the handle has a first surface extending substantially perpendicular to the longitudinal axis of the motor case;
a circular saw blade rotatably driven by the electric motor and positioned to partly extend beyond a lower surface of the base; and
a blade case joined to the first end of the motor case and arranged and constructed to cover a portion of the saw blade;
a power indication lamp mounted to the first surface of the handle and arranged and constructed to emit light when power is supplied to the circular saw.

6. The circular saw as in claim 5,
wherein the first surface is defined on one side of the handle proximal to the first end of the motor case; and
wherein the blade case has a second surface opposing to the first surface of the handle and extending substantially perpendicular to the longitudinal axis of the motor case; and
wherein a space is defined between the first surface and the second surface, so that the power indication lamp opposes the space.

7. The circular saw as in claim 6,
wherein the second surface is configured to reflect at least some of the light emitted from the power indication lamp.

8. The circular saw as in claim 6,
wherein the power indication lamp is positioned on a rear side of the handle with respect to a cutting direction of the circular saw.

9. The circular saw as in claim 8, further comprising a second lamp positioned on a front side of the handle and arranged and constructed to emit light towards a portion of the workpiece that will be cut during a cutting operation.

10. The circular saw as in claim 8,
wherein the saw unit has a front portion with respect to the cutting direction;
wherein the front portion of the saw unit is pivotally mounted to the base.

11. The circular saw as in claim 5,
wherein the power indication lamp comprises a light source and a lens mounted within the handle, so that the light is generated by the light source and is emitted to the outside of the handle via the lens,
wherein the lens has a front end extending beyond the handle and a rear end positioned within the handle and opposing the light source.

12. The circular saw as in claim 11,
wherein the front end of the lens is configured to diffuse the light emitted from the light source.

13. The circular saw as in claim 12,
wherein the front end has a conical outer circumferential surface and a central recess having a conical inner circumferential surface;
wherein the outer circumferential surface of the front end has a diameter decreasing in a direction away from the handle; and
wherein the conical inner circumferential surface of the central recess has a diameter increasing in a direction away from the handle.

14. The circular saw as in claim 12,
wherein the rear end of the lens has a substantially cylindrical recess configured to partly receive the light source.

15. The circular saw as in claim 11,
wherein the light source comprises an LED.

16. A power driven circular saw comprising:
a base arranged and constructed to slidingly contact a workpiece; and
a saw unit supported on the base, the saw unit comprising:
a motor case accommodating an electric motor and having a first end and a second end along a longitudinal axis;
a handle extending from the motor case and arranged and constructed to be grasped by an operator, wherein the handle has a first surface extending substantially perpendicular to the longitudinal axis of the motor case;
a circular saw blade rotatably driven by the electric motor and positioned to partly extend beyond a lower surface of the base; and
a blade case joined to the first end of the motor case and arranged and constructed to cover a portion of the saw blade;
a power indication lamp mounted to the first surface of the handle and arranged and constructed to emit light when power is supplied to the circular saw;
wherein the position of the power indication lamp is determined such that the power indication lamp is oriented upward relative to a surface on which the circular saw is placed in a resting position;
wherein the resting position includes one of an inclined resting position or an inverted inclined resting position;
wherein the inclined resting position includes the circular saw oriented so that an end portion of the base and a lower portion of the second end of the motor case contact the surface; and
wherein the inverted inclined resting position includes the circular saw oriented so that an upper end of the handle and a upper portion of the second end of the motor case contact the surface.

17. The power driven circular saw as in claim 16,
wherein the power indication lamp comprises an LED as a light source.

18. The circular saw as in claim 16,
wherein the first surface is defined on one side of the handle proximal to the first end of the motor case; and
wherein the blade case has a second surface opposing to the first surface of the handle and extending substantially perpendicular to the longitudinal axis of the motor case; and
wherein a space is defined between the first surface and the second surface, so that the power indication lamp opposes the space; and
wherein the second surface is configured to reflect at least some of the light emitted from the power indication lamp.
